(19) United States
(12) Patent Application Publication
(10) Pub. No.: US 2017/0038343 A1
(43) Pub. Date: Feb. 9, 2017

(54) BOX-IN-BOX GAS SENSOR HOUSING

(71) Applicants: Abhijeet Vikram Kshirsagar, Pune (IN); Chinmaya Rajiv Dandekar, Pune (IN); Amit Barjatya, Barnagar (IN); Shalini Tripathy, Doranda (IN); Taruna Khandelwal, Pune (MH) (IN)

(72) Inventors: Abhijeet Vikram Kshirsagar, Pune (IN); Chinmaya Rajiv Dandekar, Pune (IN); Amit Barjatya, Barnagar (IN); Shalini Tripathy, Doranda (IN); Taruna Khandelwal, Pune (MH) (IN)

(21) Appl. No.: 14/821,562

(22) Filed: Aug. 7, 2015

(51) Int. Cl. G01N 29/24; G01N 29/22; G01N 29/02

(52) U.S. Cl. CPC G01N 29/2418; G01N 29/02; G01N 29/222; G01N 2291/021

(57) ABSTRACT

A housing for a gas sensor module is described herein. The housing can include an outer portion and an inner portion disposed within the outer portion. The outer portion can include at least one wall forming a first cavity. The outer portion can also include an inlet tube coupling feature disposed at a first location in the at least one first wall, and an outlet tube coupling feature disposed in a second location in the at least one first wall. The inner portion can include at least one second wall forming a second cavity, and a distribution channel coupling feature disposed at a third location in the at least one second wall. The inner portion can also include a receiving channel coupling feature disposed in a fourth location and a tuning fork coupling feature disposed at a fifth location in the at least one second wall.

### TECHNICAL FIELD

Embodiments described herein relate generally to gas sensors, and more particularly to systems, methods, and devices for housings for optical gas sensors.

### BACKGROUND

The detection and measurement of trace gas concentrations is important for both the understanding and monitoring of a wide variety of applications, such as environmental monitoring, industrial process control analysis, combustion processes, detection of toxic and flammable gases, as well as explosives. For example, trace gas sensors capable of high sensitivity and selectivity can be used in atmospheric science for the detecting and monitoring of different trace gas species including greenhouse gases and ozone, and in breath diagnostics, for detection and monitoring of nitric oxide, ethane, ammonia and numerous other biomarkers. As another example, in gas-to-grid applications, methane generated from a biogas process is tested for impurities (e.g., hydrogen sulfide or H₂S) to determine whether the methane is pure enough to be mixed directly with natural gas.

### SUMMARY

In general, in one aspect, the disclosure relates to a housing for a gas sensor module. The housing can include an outer portion. The outer portion of the housing can include at least one first wall forming a first cavity. The outer portion of the housing can also include an inlet tube coupling feature disposed at a first location in the at least one first wall. The outer portion of the housing can further include an outlet tube coupling feature disposed in a second location in the at least one first wall, where the second location is adjacent to the first cavity. The housing can also include an inner portion disposed within the first cavity. The inner portion of the housing can include at least one second wall forming a second cavity. The inner portion of the housing can also include a distribution channel coupling feature disposed at a third location in the at least one second wall, where the third location is adjacent to the second cavity. The inner portion of the housing can further include a receiving channel coupling feature disposed in a fourth location in the at least one second wall, where the fourth location is adjacent to the second cavity. The inner portion of the housing can also include a tuning fork coupling feature disposed at a fifth location in the at least one second wall, where the fifth location is adjacent to the second cavity.

In another aspect, the disclosure can generally relate to a gas sensor. The gas sensor can include a housing. The housing of the gas sensor can include an outer portion. The outer portion of the housing can include at least one first wall forming a first cavity, and an inlet tube coupling feature disposed at a first location in the at least one first wall, where the first location is adjacent to the first cavity. The outer portion of the housing further include an outlet tube coupling feature disposed in a second location in the at least one first wall, where the second location is adjacent to the first cavity. The housing of the gas sensor can include an inner portion disposed within the first cavity of the outer portion. The inner portion of the housing can include at least one second wall forming a second cavity, and a tuning fork coupling feature disposed at a third location in the at least one second wall, where the third location is adjacent to the second cavity. The inner portion of the housing can also include a distribution channel disposed at a fourth location in the at least one second wall, where the fourth location is adjacent to the second cavity. The inner portion of the housing can further include a receiving channel disposed at a fifth location in the at least one second wall, where the fifth location is adjacent to the second cavity. The gas sensor can also include an inlet tube coupled to the inlet tube coupling feature, and an outlet tube coupled to the outlet tube coupling feature. The gas sensor can further include a tuning fork coupled to the tuning fork coupling feature.

These and other aspects, objects, features, and embodiments will be apparent from the following description and the appended claims.

### BRIEF DESCRIPTION OF THE DRAWINGS

The drawings illustrate only example embodiments of housings for optical gas sensors and are therefore not to be considered limiting of its scope, as housings for optical gas sensors may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show an outer portion of a gas sensor housing in accordance with certain example embodiments.

FIGS. 2A and 2B show an inner portion of a gas sensor housing in accordance with certain example embodiments.

FIGS. 3A and 3B show another inner portion of a gas sensor housing in accordance with certain example embodiments.

FIG. 4 shows a cross-sectional side view of a gas sensor housing in accordance with certain example embodiments.

FIG. 5 shows a cross-sectional side view of another gas sensor housing in accordance with certain example embodiments.

FIG. 6 shows a semi-transparent cross-sectional top side perspective view of a portion of a gas sensor module in accordance with certain example embodiments.

FIG. 7 shows a semi-transparent cross-sectional top side perspective view of another portion of a gas sensor module in accordance with certain example embodiments.

### DETAILED DESCRIPTION OF EXAMPLE EMBODIMENTS

The example embodiments discussed herein are directed to systems, apparatuses, and methods related to housings for optical gas sensors. Optical gas sensors, including the example housings, can have a number of configurations and use a number of technologies. For example, a quartz-enhanced photo-acoustic spectroscopic (QEPAS) sensor can have an optical irradiation at a gas-specific wavelength directed through a gap between the prongs of a quartz tuning fork (QTF) vibrating at its resonating frequency. The optical energy is absorbed and released by the gas, causing a change in the resonant frequency of the QTF. The amount of change in the resonant frequency of the QTF is proportional to the concentration of the gas molecules.

While example embodiments are described herein as being “box-in-box”, this description is merely meant to describe that one part of the housing is disposed within another part of the housing. A part of an example housing can have the shape of a box (also called a rectangular parallelepiped), or any other suitable shape (e.g., a cylinder, a sphere, an ellipsoid, a cube). Further, while example embodiments are directed to optical gas sensors, example embodiments can also be used with other types of sensors. Further, optical gas sensors that can be used with example embodiments can have any of a number of configurations not shown or described herein. As described herein, a user can be any person that interacts with example optical gas sensors. Examples of a user may include, but are not limited to, a consumer, an operations specialist, a gas engineer, a supervisor, a consultant, a contractor, an operator, and a manufacturer's representative.

In one or more example embodiments, example housings for optical gas sensors are subject to meeting certain standards and/or requirements. For example, the International Electrotechnical Commission (IEC) sets standards, such as IEC 60079-28 that applies to optical gas sensors, with which example housings must comply to be used in field applications. Examples of other entities that set applicable standards and regulations include, but are not limited to, the National Electrical Manufacturers Association (NEMA), the National Electric Code (NEC), the Institute of Electrical and Electronics Engineers (IEEE), and Underwriters Laboratories (UL).

In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill. The housings for optical gas sensors (or components thereof) described herein can be physically placed in and/or used with corrosive components (e.g., gases). In addition, or in the alternative, example housings for optical gas sensors (or components thereof) can be subject to extreme heat, extreme cold, moisture, humidity, dust, and other conditions that can cause wear on the housings for optical gas sensors or portions thereof.

In certain example embodiments, the housings for optical gas sensors, including any components and/or portions thereof, are made of one or more materials that are designed to maintain a long-term useful life and to perform when required without mechanical and/or other types of failure. Examples of such materials can include, but are not limited to, aluminum, stainless steel, fiberglass, glass, plastic, ceramic, nickel-based alloys, and rubber. Such materials can be resistant to corrosion, corrosive materials (e.g., H₂S gas) and other harmful effects that can be caused by the test gas, the tested gas, and/or the environment in which the gas sensor housing is exposed.

Any components (e.g., inlet tube coupling feature, receiving channel) of example box-in-box housings for optical gas sensors, or portions thereof, described herein can be made from a single piece (as from a mold, injection mold, die cast, or extrusion process). In addition, or in the alternative, a component (or portions thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting, or other similar terms. Such terms are merely meant to distinguish various elements and/or features within a component or device and are not meant to limit the capability or function of that particular element and/or feature. For example, a feature described as a “coupling feature” can couple, secure, fasten, abut, and/or perform other functions aside from, or in addition to, merely coupling.

A coupling feature (including a complementary coupling feature) as described herein can allow one or more components (e.g., portions of a housing) and/or portions of optical gas sensors to become mechanically and/or electrically coupled, directly or indirectly, to another portion of the optical gas sensor. A coupling feature can include, but is not limited to, a clamp, a portion of a hinge, an aperture, a recessed area, a protrusion, a slot, a spring clip, a tab, a detent, a threaded coupling, and mating threads. One portion of an example optical gas sensor can be coupled to another portion of the optical gas sensor by the direct use of one or more coupling features. In addition, or in the alternative, a portion of an example optical gas sensor can be coupled to another portion of the optical gas sensor using one or more independent devices (also called coupling features) that interact with one or more coupling features disposed on a component of the optical gas sensor. Examples of such devices can include, but are not limited to, a pin, a hinge, a fastening device (e.g., a bolt, a screw, a rivet), and a spring.

One coupling feature described herein can be the same as, or different than, one or more other coupling features described herein. A complementary coupling feature as described herein can be a coupling feature that mechanically couples, directly or indirectly, with another coupling feature. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is represented by a three digit number, and the three digit number representing corresponding components in other figures have the identical last two digits.

Example embodiments of box-in-box housings for optical gas sensors will be described more fully hereinafter with reference to the accompanying drawings, in which example box-in-box housings for optical gas sensors are shown. Box-in-box housings for optical gas sensors may, however, be embodied in many different forms and should not be construed as limited to the example embodiments set forth herein. Rather, these example embodiments are provided so that this disclosure will be thorough and complete, and will fully convey the scope of box-in-box housings for optical gas sensors to those of ordinary skill in the art. Like, but not necessarily the same, elements (also sometimes called components) in the various figures are denoted by like reference numerals for consistency.

Terms such as “top”, “bottom”, “left”, “right”, “front”, “back”, “side”, “inner”, “outer”, “end”, “distal”, “proximal”, “first”, and “second” are used merely to distinguish one component (or part of a component or state of a component) from another. Such terms are not meant to denote a preference or a particular orientation, and are not meant to limit embodiments of box-in-box housings for optical gas sensors. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Also, the names given to various components described herein are descriptive of example embodiments and are not meant to be limiting in any way. Those skilled in the art will appreciate that a feature and/or component shown and/or described in one embodiment (e.g., in a figure) herein can be used in another embodiment (e.g., in any other figure) herein, even if not expressly shown and/or described in such other embodiment.

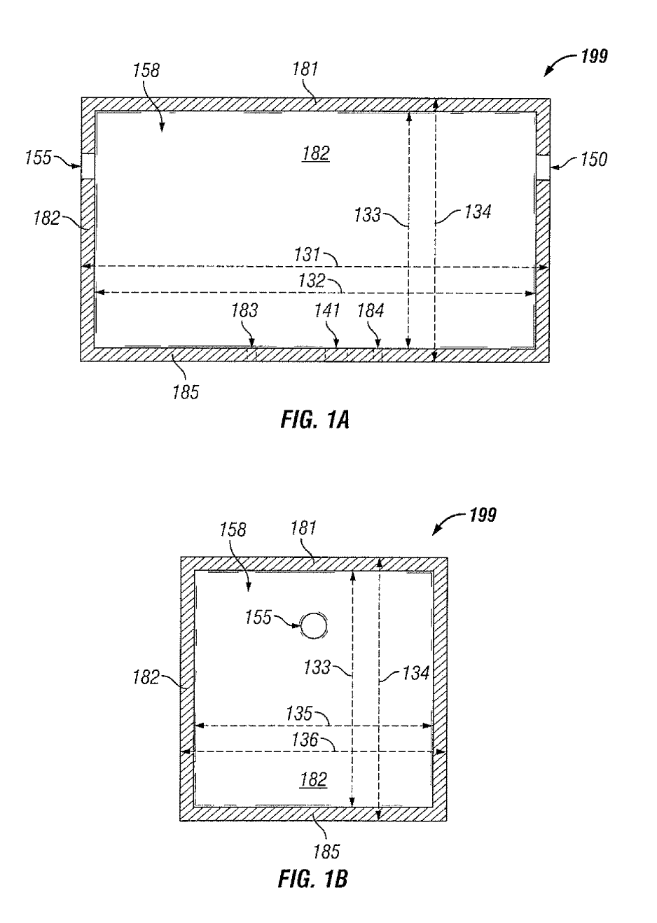

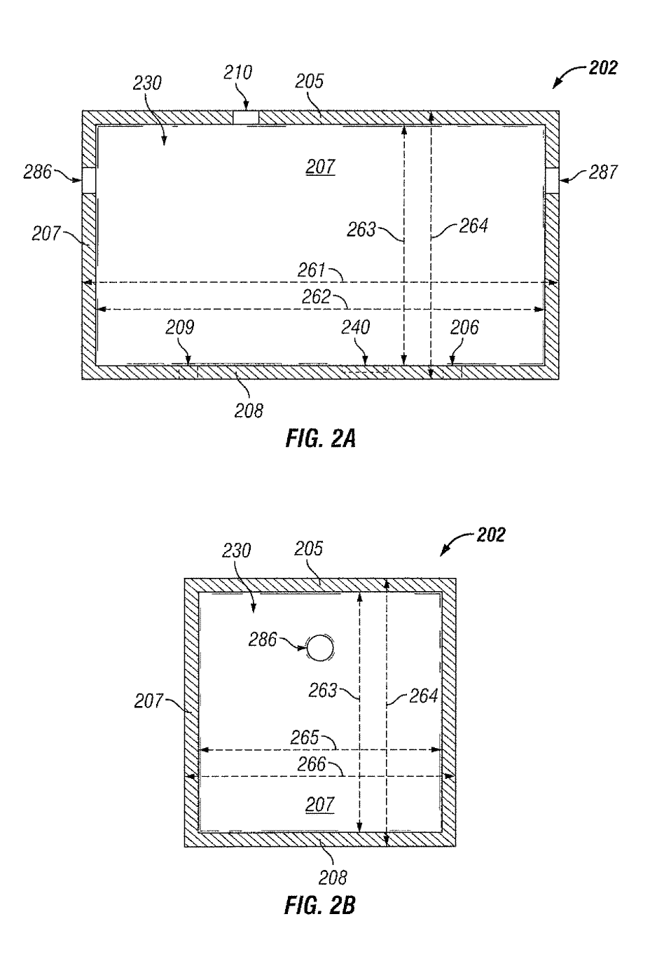

The gas sensor housing of a gas sensor can be configured to perform any measurements of the gas being tested (also called the test gas herein). For this to occur, the various portions (e.g., outer portion 199 of FIGS. 1A and 1B, inner portion 202 of FIGS. 2A and 2B below) of the example housing can be configured with respect to each other in such a way that one portion (e.g., outer portion 199) delivers the test gas to another portion (e.g., inner portion 202), and also receives the tested gas (the test gas that has been tested) from the other portion (e.g., inner portion 202) of the housing.

In certain example embodiments, box-in-box gas sensor housings described herein have multiple (e.g., two, three) portions. In such a case, one portion of the housing is nested within (disposed within) another portion of the housing. As a result, the portion of the housing nested within another portion of the housing is hereby referred to as an inner portion of the housing, and the portion of the housing that encompasses another portion of the housing is hereby referred to as an outer portion of the housing. FIGS. 1A and 1B show an outer portion 199 of a gas sensor housing in accordance with certain example embodiments. Specifically, FIG. 1A shows a cross-sectional side view of the outer portion 199, and FIG. 1B shows a cross-sectional front view of the outer portion 199.

The outer portion 199 of the gas sensor housing can have at least one wall (in this case, a top wall 181, a bottom wall 185, and a number of side walls 182) that forms a cavity 158. The outer portion 199 of the housing can have any of a number of shapes and sizes. For example, the outer portion 199 of the housing shown in FIGS. 1A and 1B is a rectangular parallelepiped in shape. In such a case, the outer portion 199 has a length 131, a width 136, and a height 134.

Similarly, the cavity 158 formed by the inner surface of the walls of the outer portion 199 also has a length 132, a width 135, and a height 133 in this case. The difference between the length 131, the width 136, and the height 134 of the outer portion 199 and the length 132, the width 135, and the height 133 of the cavity 158 is substantially the same as the thickness of the walls (e.g., top wall 181, bottom wall 185, side walls 182) that define a particular dimension of the outer portion 199.

The cavity 158 of the outer portion 199 can be completely enclosed, substantially enclosed, or partially enclosed. For example, as shown in FIGS. 1A and 1B, the cavity 158 of the outer portion 199 is substantially completely enclosed. In certain example embodiments, the cavity 158 of the outer portion 199 has one or multiple (e.g., two, three, four) portions. For example, in this case the cavity 158 of the outer portion 199 has a single portion. As an alternative, the cavity 158 can be divided into two cavity portions that are separated from each other by a partition (not shown). In such a case, the partition can have or include one or more of a number of characteristics. Examples of such characteristics can include, but are not limited to, a solid configuration, a porous material, a non-porous material, a mesh, and an orifice. A partition in the cavity 158 can be disposed against some or all of the inner portion (e.g., inner portion 202, inner portion 302) of the housing.

When the cavity 158 of the outer portion 199 of the housing is physically separated into multiple portions by a partition, the partition can substantially isolate one portion of the cavity 158 from the rest of the cavity 158. A partition can be temporary or permanent with respect to its position in the cavity 158 of the outer portion 199. The partition can help separate the test gas from the tested gas. The partition can also help direct test gas toward the inner portion of the housing. In addition, the partition can help reduce and/or control the flow rate and/or turbulent flow of the test gas, which in turn can control the flow of the test gas sent to the inner portion (e.g., inner portion 202) of the housing. The partition can also help regulate one or more of a number of parameters (e.g., pressure) within the cavity 158 of the outer portion 199. If the cavity 158 of the outer portion 199 is divided into multiple portions, the shape and size of one portion of the cavity 158 can be the same as, or different than, the shape and size of the other portions of the cavity 158.

In certain example embodiments, the cavity 158 of the outer portion 199 of the housing can include one or more features that channel the flow of gas (e.g., test gas, tested gas) through the cavity 158. Examples of such features can include, but are not limited to, contoured inner surfaces of a wall and baffles. For example, cavity 158 can include baffles that channel test gas that flows from the inlet tube coupling feature 150 through the cavity 158 to the distribution channel coupling feature 287 of the inner portion 202 (described below). Such features can affect other aspects (e.g., turbulence, flow rate) of the test gas and/or tested gas.

In certain example embodiments, the outer portion 199 is coupled to one or more other portions (e.g., inner portion 202, inner portion 302) of the housing. The outer portion 199 can be coupled to an inner portion using one or more of a number of coupling features 184 (sometimes called an inner portion coupling feature 184). For example, in FIGS. 1A and 1B, the coupling feature 184 is an aperture that traverse the thickness of the bottom wall 185 of the outer portion 199. When a coupling feature 184 is an aperture, such as in this case, each coupling feature 184 can receive a fastening device (e.g., a bolt, a screw, a rivet) that is used to couple the outer portion 199 to the inner portion.

The characteristics (e.g., shape, size, configuration) of the coupling features 184 can be configured to correspond to the associated characteristics of coupling features (e.g., coupling features 206, described below) of the inner portion. In such a case, the outer portion 199 can be coupled to the inner portion in one or more of a number of orientations. The outer portion 199 can include one or more features to accommodate the coupling features 184. For example, there can be mating threads disposed along the inner surface of the bottom wall 185 that forms the coupling feature 184. In alternative embodiments, the coupling feature 184 can be one or more slotted fittings disposed on an inner surface of the bottom wall 185. In yet another alternative embodiment, the coupling feature 184 is the inner surface of the bottom wall 185, where solder, adhesive, or some similar type of coupling feature is used to couple the outer portion 199 to the inner portion.

In addition, or in the alternative, one or more optional passageways 183 (e.g., apertures) can be disposed in one or more walls (e.g., side wall 182, bottom wall 185) of the outer portion 199. In such a case, the passageway 183 can allow one or more components (e.g., electrical conductor, gas line) to pass therethrough. In such a case, those components can be disposed, in part, in the cavity 158 of the outer portion 199 (which can include the cavity 230 of the inner portion 202), and in part outside of the outer portion 199. If a passageway 183 is included with the outer portion 199, a sealing member (e.g., a gasket, an o-ring, silicone) can be used to provide a barrier that prevents potentially corrosive materials (e.g., test gas) in the cavity 158 from leaving the cavity 199.

In certain example embodiments, the outer portion 199 of the housing includes one or more features that interact with one or more other components of the housing and/or an optical gas sensor. For example, as shown in FIGS. 1A and 1B, the outer portion 199 can include an inlet tube coupling feature 150, an outlet tube coupling feature 155, and an optional tuning fork coupling feature 141. Other coupling features of the outer portion 199, while not shown in FIGS. 1A and 1B, can include, but are not limited to, a distribution channel coupling feature and a receiving channel coupling feature.

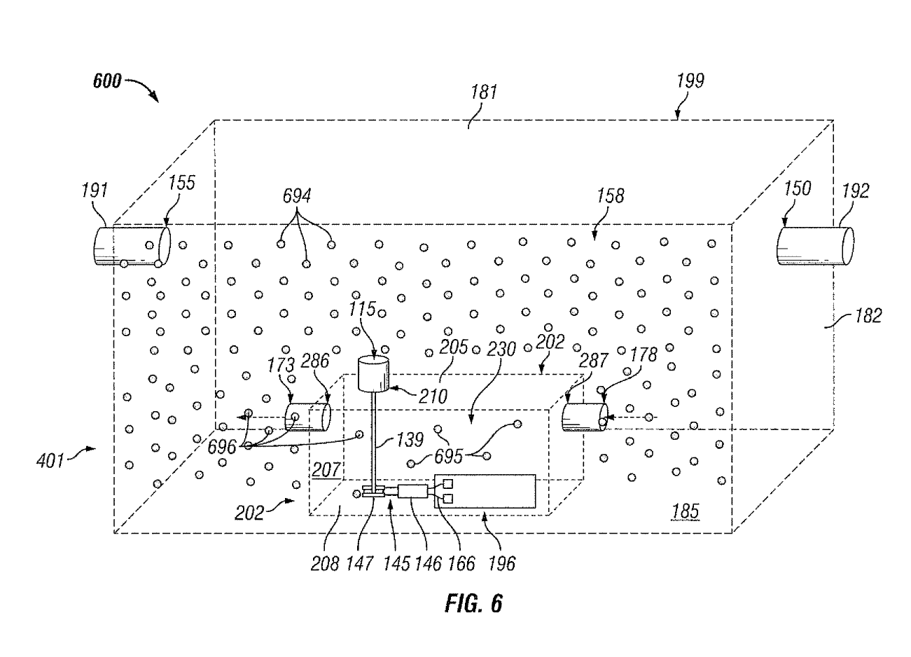

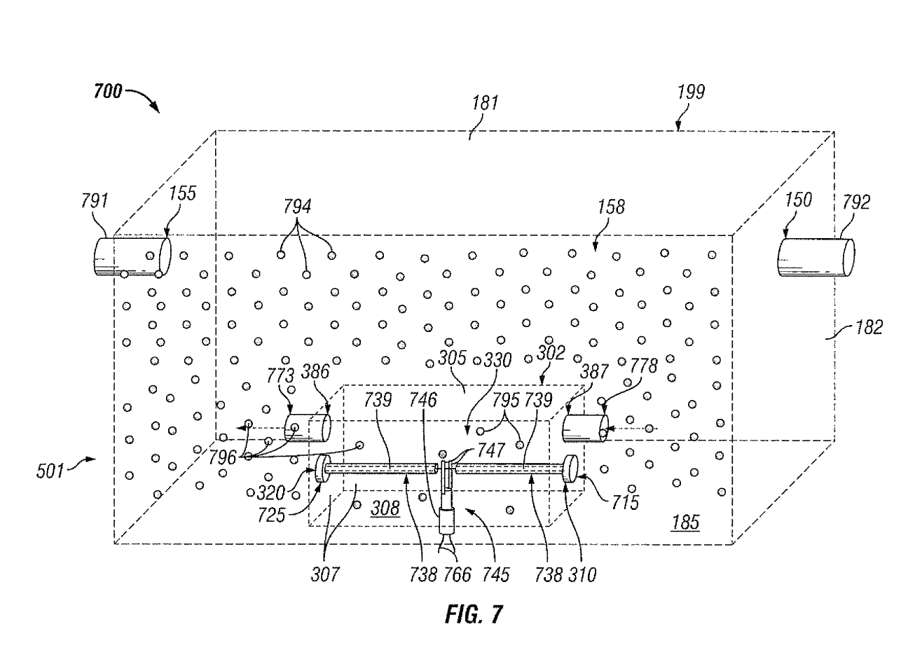

Returning to FIGS. 1A and 1B, the inlet tube coupling feature 150 can couple to the inlet tube of a gas sensor module, as shown below with respect to FIGS. 6 and 7. The inlet tube coupling feature 150 can include one or more of a number of coupling features. For example, in this case, the inlet tube coupling feature 150 can be an aperture that traverses a side wall 182 of the outer portion 199. The inlet tube is configured to deliver test gas into the cavity 158 of the outer portion 199 of the housing.

The outlet tube coupling feature 155 of the top portion 199 can couple to an outlet tube (described below with respect to FIGS. 6 and 7). The outlet tube coupling feature 155 can include one or more of a number of coupling features. For example, in this example, the outlet tube coupling feature 155 can be an aperture that traverses a side wall 182 of the outer portion 199. The inlet tube is configured to remove tested gas from the cavity 158 of the outer portion 199 of the housing. The wall in which the outlet tube coupling feature 155 is disposed can be the same wall as, or a different wall than, the wall in which the inlet tube coupling feature 150 is disposed. For example, in this case, the outlet tube coupling feature 155 is disposed in a side wall 182 that is at an opposite end of the outer portion 199 relative to the side wall 182 in which the inlet tube coupling feature 150 is disposed.

In certain example embodiments, the outer portion 199 of the housing can include multiple components that are mechanically coupled to each other. For example, the top wall 181 can be a separate component from the side walls 182 of the outer portion 199. In such a case, the top wall 181 can be coupled to the side walls 182 in one or more of a number of ways (e.g., fixedly, removably, hingedly). In such a case, one or more of the multiple components of the outer portion 199 can include one or more coupling features that allow one component to couple to another component of the outer portion 199.

In any case, when the various pieces of the outer portion 199 couple to each other, the cavity 158 of the outer portion 199 becomes substantially whole and continuous. Further, when the various pieces are coupled to each other, the associated coupling features (e.g., the inlet tube coupling feature 150, the outlet tube coupling feature 155, the tuning fork coupling feature 141 (described below)) can be made whole. In such a case, one or more of these pieces can include additional coupling features to facilitate coupling those pieces to each other.

The optional tuning fork coupling feature 141 (or portion thereof) can couple, directly or indirectly, to a tuning fork (e.g., tuning fork 645 of FIG. 6 below, tuning fork 745 of FIG. 7 below). The tuning fork coupling feature 141 can have a shape and size to host one or more of a number of tuning forks. The tuning fork coupling feature 141 can be disposed at any location along an inner surface of a wall (e.g., bottom wall 185) that forms the cavity 158. For example, as shown in FIGS. 1A and 1B, the tuning fork coupling feature 141 can be disposed in the approximate center of the inner surface of the bottom wall 185 adjacent to the cavity 158.

The tuning fork coupling feature 141 can include any of a number of features (e.g., a collar, a notch, a protrusion, a recess) to help in coupling the tuning fork with the tuning fork coupling feature 141. In addition, the tuning fork coupling feature 141 can be disposed along an inner surface of another wall (e.g., side wall 182) adjacent to the cavity 158. One or more characteristics (e.g., shape, size, location) of the tuning fork coupling feature 141 can complement the corresponding characteristics of the tuning fork coupling feature 240 of the inner portion, as described below.

In certain example embodiments, the various coupling features (e.g., the inlet tube coupling feature 150, the outlet tube coupling feature 155, the tuning fork coupling feature 141) of the outer portion 199 can be sized and/or arranged in a particular way, based on the characteristics of the components that couple to those coupling features, in order to achieve certain test results and/or to meet certain applicable standards.

As discussed above, the box-in-box configuration of the example housing described herein includes an inner portion disposed within the outer portion (e.g., outer portion 199 of FIGS. 1A and 1B). FIGS. 2A and 2B show an inner portion 202 of a gas sensor housing in accordance with certain example embodiments. Specifically, FIG. 2A shows a cross-sectional side view of the inner portion 202, and FIG. 2B shows a cross-sectional front view of the inner portion 202.

Referring to FIGS. 1A-2B, the inner portion 202 of the gas sensor housing can have at least one wall (in this case, a top wall 205, a bottom wall 208, and a number of side walls 207) that forms a cavity 230. The inner portion 202 of the housing can have any of a number of shapes and sizes. The cavity 230 forming the walls of the inner portion 202 can have a shape and size sufficient to test the test gas distributed into the cavity 230 based on the other components (e.g., tuning fork, optical device) used to test the test gas. In this case, the inner portion 202 of the housing shown in FIGS. 2A and 2B is a rectangular parallelepiped in shape. In such a case, the inner portion 202 has a length 261, a width 266, and a height 264. Since the inner portion 202 is disposed within the outer portion 199 of the housing, the length 261, the width 266, and the height 264 of the inner portion 202 are less than or equal to the length 132, the width 135, and the height 133, respectively, of the cavity 158 of the outer portion 199.

Similarly, the cavity 230 formed by the inner surface of the walls of the inner portion 202 also has a length 262, a width 265, and a height 263 in this case. The difference between the length 261, the width 266, and the height 264 of the inner portion 202 and the length 262, the width 265, and the height 263 of the cavity 230 is substantially the same as the thickness of the walls (e.g., top wall 205, bottom wall 208, side walls 207) that define a particular dimension of the inner portion 202.

The cavity 230 of the inner portion 202 can be completely enclosed, substantially enclosed, or partially enclosed. For example, as shown in FIGS. 2A and 2B, the cavity 230 of the inner portion 202 is substantially completely enclosed. In certain example embodiments, the cavity 230 of the inner portion 202 has one or multiple (e.g., two, three, four) portions. For example, in this case the cavity 230 of the inner portion 202 has a single portion. As an alternative, the cavity 230 can be divided into two cavity portions that are separated from each other by a partition (not shown). In such a case, the partition can have or include one or more of a number of characteristics. Examples of such characteristics can include, but are not limited to, a solid configuration, a porous material, a non-porous material, a mesh, and an orifice.

When the cavity 230 of the inner portion 202 of the housing is physically separated into multiple portions by a partition, the partition can substantially isolate one portion of the cavity 230 from the rest of the cavity 230. A partition can be temporary or permanent with respect to its position in the cavity 230 of the inner portion 202. The partition can help separate the test gas from the tested gas. The partition can also help direct test gas toward the testing components (e.g., tuning fork) of the inner portion 202. In addition, the partition can help reduce and/or control the flow rate and/or turbulent flow of the test gas and/or tested gas within the inner portion 202. The partition can also help regulate one or more of a number of parameters (e.g., pressure) within the cavity 230 of the inner portion 202. If the cavity 230 of the inner portion 202 is divided into multiple portions, the shape and size of one portion of the cavity 230 can be the same as, or different than, the shape and size of the other portions of the cavity 230.

In certain example embodiments, the cavity 230 of the inner portion 202 of the housing can include one or more features that channel the flow of gas (e.g., test gas, tested gas) through the cavity 230. Examples of such features can include, but are not limited to, contoured inner surfaces of a wall and baffles. For example, the cavity 230 can include baffles that channel test gas that flows from the distribution channel coupling feature 287 through the cavity 230 to the receiving channel coupling feature 286 of the inner portion 202. Such features can affect other aspects (e.g., turbulence, flow rate) of the test gas and/or tested gas.

In certain example embodiments, the inner portion 202 is coupled to one or more other portions (e.g., outer portion 199) of the housing. The inner portion 202 can be coupled to the outer portion of the housing using one or more of a number of coupling features 206 (sometimes called an outer portion coupling feature 206). For example, in FIGS. 2A and 2B, the coupling feature 206 is an aperture that traverses the thickness of the bottom wall 208 of the inner portion 202. When a coupling feature 206 is an aperture, such as in this case, each coupling feature 206 can receive a fastening device (e.g., a bolt, a screw, a rivet) that is used to couple the inner portion 202 to the outer portion.

The characteristics (e.g., shape, size, configuration) of the coupling features 206 can be configured to correspond to the associated characteristics of coupling features (e.g., coupling features 184) of the outer portion 199. In such a case, the inner portion 202 can be coupled to the outer portion 199 in one or more of a number of orientations. For example, the coupling features 206 of the inner portion 202 can have the same size and orientation compared to the shape and size of the coupling features 184 of the outer portion 199. In this way, when the outer portion 199 couples to (e.g., abuts against) the inner portion 202, the coupling features 184 and the coupling features 206 are aligned with each other so that one or more fastening devices can be disposed therein to couple the inner portion 202 and the outer portion 199 together.

The inner portion 202 can include one or more features to accommodate the coupling features 206. For example, there can be mating threads disposed along the inner surface of the bottom wall 208 that forms the coupling feature 206. In alternative embodiments, the coupling feature 206 can be one or more slotted fittings disposed on an inner surface of the bottom wall 208. In yet another alternative embodiment, the coupling feature 206 is the outer surface of the bottom wall 208, where solder, adhesive, or some similar type of coupling feature is used to couple the inner portion 202 to the outer portion 199.

In certain example embodiments, one or more parts of the inner portion 202 can be omitted. For example, the inner portion 202 can have no bottom wall 208. In such a case, the coupling features 206 can be disposed in one or more side walls 207. Further, in such a case, the cavity 230 can be enclosed, in part, by the bottom wall 185 of the outer portion 199 when the inner portion 202 is coupled to the outer portion 199.

When the inner portion 202 includes a bottom wall 208, one or more optional passageways 209 (e.g., apertures) can be disposed in one or more walls (e.g., side wall 207, bottom wall 208) of the inner portion 202. In such a case, the passageway 209 can allow one or more components (e.g., electrical conductor, gas line) to pass therethrough. When this occurs, those components can be disposed, in part, in the cavity 230 of the inner portion 202, and in part outside of the inner portion 202 (which can still be within the cavity 158 of the outer portion 199). One or more characteristics (e.g., shape, size, location) of a passageway 209 can be based on corresponding characteristics of a passageway 183 in the outer portion 199. If a passageway 209 is included with the inner portion 202, a sealing member (e.g., a gasket, an o-ring, silicone) can be used to provide a barrier that prevents potentially corrosive materials (e.g., test gas) in the cavity 230 from leaving the cavity 230.

In certain example embodiments, the inner portion 202 of the housing includes one or more features that interact with one or more other components of the housing and/or an optical gas sensor. For example, as shown in FIGS. 2A and 2B, the inner portion 202 can include a distribution channel coupling feature 287, a receiving channel coupling feature 286, an optical device coupling feature 210, and a tuning fork coupling feature 240.

To deliver the test gas from the cavity 158 of the outer portion 199 to the cavity 230 of the inner portion 202 of the housing, the inner portion 199 can include one or more distribution channel coupling features 287. In such a case, the distribution channel coupling feature 287 can couple to at least one distribution channel (e.g., distribution channel 178, described below with respect to FIG. 6). Alternatively, or in addition, the distribution channel coupling feature 287 can include one or more features (e.g., side walls) sufficient to allow test gas to pass directly or indirectly therethrough. The distribution channel coupling feature 287 can include one or more of a number of coupling features. For example, in this case, the distribution channel coupling feature 287 is an aperture that is configured to directly or indirectly receive and allow test gas to flow therethrough.

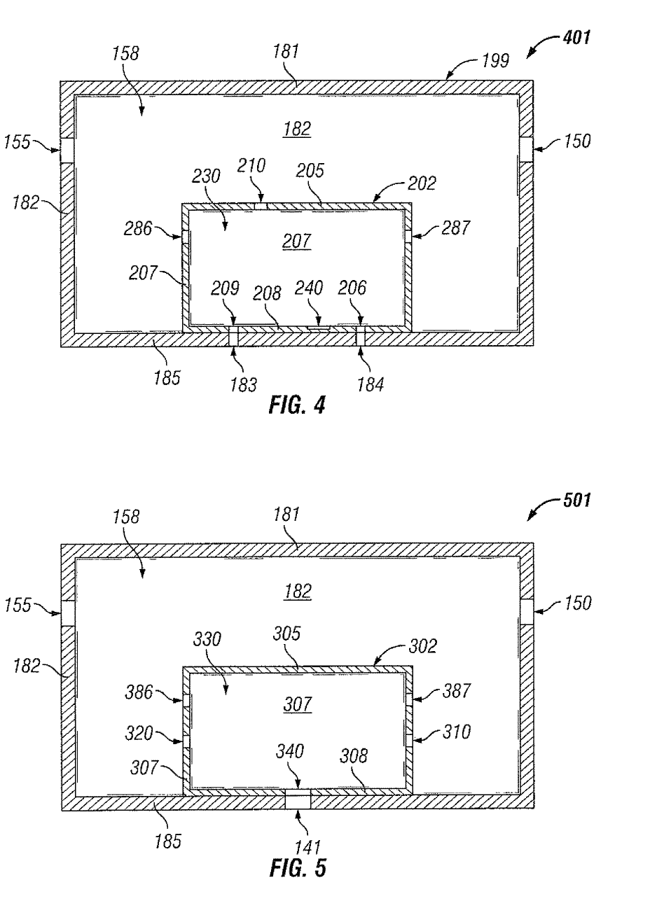

The distribution channel coupling feature 287 can be disposed, at least in part, in a wall (e.g., side wall 207) of the inner portion 202. Further, the distribution channel coupling feature 287 can be located adjacent to the cavity 158 of the outer portion 199. In certain example embodiments, as shown in FIGS. 4 and 5 below, the distribution channel coupling feature 287 is located adjacent to the inlet tube coupling feature 150 of the outer portion 199.

Once the test gas is tested inside the cavity 230 of the inner portion 202, the resulting gas (called the tested gas) is removed from the cavity 230 of the inner portion 202. To receive the tested gas by the outer portion 199 from the inner portion 202, the inner portion 202 can include one or more receiving channel coupling features 286 that can couple to at least one receiving channel (e.g., receiving channel 173, described below with respect to FIG. 6). Alternatively, the receiving channel coupling feature 286 can include one or more features (e.g., side walls) sufficient to allow tested gas to pass directly or indirectly therethrough. The receiving channel coupling feature 286 can include one or more of a number of coupling features. For example, in this case, the receiving channel coupling feature 286 is an aperture that is configured to receive and allow the tested gas to flow therethrough.

The receiving channel coupling feature 286 can be disposed, at least in part, in a wall (e.g., side wall 207) of the inner portion 202. Further, the receiving channel coupling feature 286 can be located adjacent to the cavity 158 of the outer portion 199. In certain example embodiments, as shown in FIGS. 4 and 5 below, the receiving channel coupling feature 286 is located adjacent to the outlet tube coupling feature 155 of the outer portion 199. The wall in which the receiving channel coupling feature 286 is disposed can be the same wall as, or a different wall than, the wall in which the distribution channel coupling feature 287 is disposed. For example, in this case, the receiving channel coupling feature 286 is disposed in a side wall 207 that is at an opposite end of the inner portion 202 relative to the side wall 207 in which the distribution channel coupling feature 287 is disposed.

The tuning fork coupling feature 240 (or portion thereof) can couple, directly or indirectly, to a tuning fork (e.g., tuning fork 645 of FIG. 6 below, tuning fork 745 of FIG. 7 below). The tuning fork coupling feature 240 can have a shape and size to host one or more of a number of tuning forks. The tuning fork coupling feature 240 can be disposed at any location along an inner surface of a wall (e.g., bottom wall 208) that forms the cavity 230. For example, as shown in FIGS. 2A and 2B, the tuning fork coupling feature 240 can be a recessed area that is disposed in the approximate center of the inner surface of the bottom wall 208 adjacent to the cavity 230.

The tuning fork coupling feature 240 can include any of a number of features (e.g., a collar, a notch, a protrusion, a recess) to help in coupling the tuning fork with the tuning fork coupling feature 240. In addition, the tuning fork coupling feature 240 can be disposed along an inner surface of another wall (e.g., side wall 207) adjacent to the cavity 230. One or more characteristics (e.g., shape, size, location) of the tuning fork coupling feature 240 can complement the corresponding characteristics of the tuning fork coupling feature 141 of the outer portion 199, as shown, for example, in FIG. 4 below.

The optical device coupling feature 210 can be disposed at any location along an inner surface of a wall (e.g., side wall 207) that forms the cavity 230. For example, as shown in FIGS. 2A and 2B, the optical device coupling feature 210 can be disposed in the top wall 205 at a particular lateral location relative to the tuning fork coupling feature 240 adjacent to the cavity 230. The optical device coupling feature 210 can include any of a number of features (e.g., a collar, a notch, a protrusion, a recess) to help in coupling an optical device with the optical device coupling feature 210. In addition, the optical device coupling feature 210 can be disposed on another wall (e.g., bottom wall 308) of the inner portion 202 adjacent to the cavity 230.

In addition to, or in the alternative of, the tuning fork coupling feature 240, the receiving channel coupling feature 286, the optical device coupling feature 210, and/or the distribution channel coupling feature 287, one or more other features can be disposed in a wall (e.g., side wall 207, bottom wall 208) of the inner portion 202 of the housing. Examples of such other features can include, but are not limited to, a light source coupling feature (for housing and/or coupling to a light source) and a power source coupling feature (for housing and/or coupling to a power source).

Some or all of the coupling features (e.g., the distribution channel coupling feature 287, the receiving channel coupling feature 286, tuning fork coupling feature 240) of the inner portion 202 can be sized and/or arranged in a particular way, based on the characteristics of the components that couple to those coupling features, in order to achieve certain test results and/or to meet certain applicable standards. Similarly, the inner portion 202 can be sized and/or arranged in a particular way within the cavity 158 of the outer portion 199 in order to achieve certain test results and/or to meet certain applicable standards.

In certain example embodiments, the inner portion 202 of the housing can include multiple components that are mechanically coupled to each other. For example, the top wall 205 can be a separate component from the side walls 207 of the inner portion 202. In such a case, the top wall 205 can be coupled to the side walls 207 in one or more of a number of ways (e.g., fixedly, removably, hingedly). In such a case, one or more of the multiple components of the inner portion 202 can include one or more coupling features that allow one component to couple to another component of the inner portion 202.

In any case, when the various pieces of the inner portion 202 couple to each other, the cavity 230 of the inner portion 202 becomes substantially whole and continuous. Further, when the various pieces are coupled to each other, the associated coupling features (e.g., the distribution channel coupling feature 287, the receiving channel coupling feature 286, the tuning fork coupling feature 240) can be made whole. In such a case, one or more of these pieces can include additional coupling features to facilitate coupling those pieces to each other.

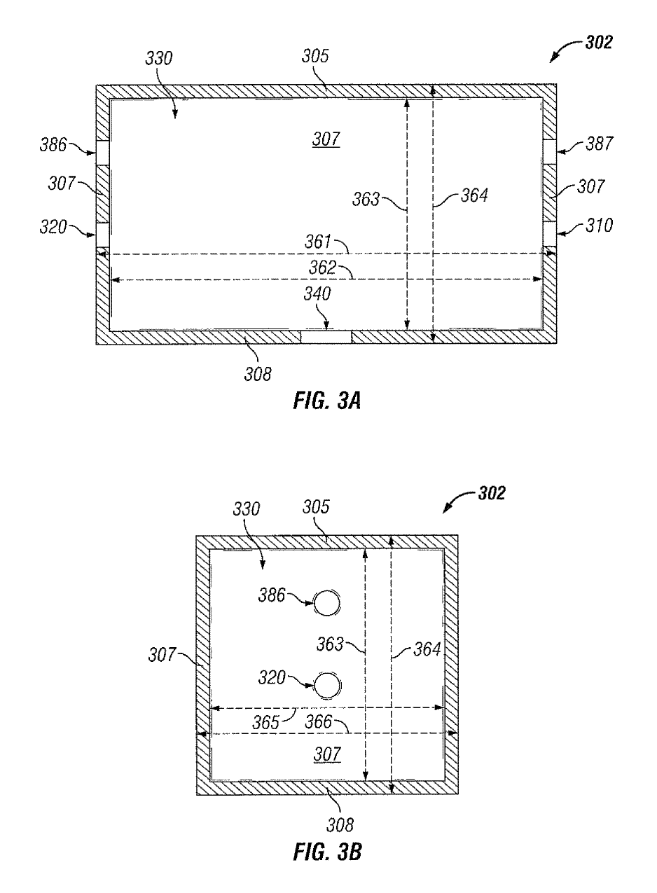

As discussed above, any portion (e.g., inner portion, outer portion) of the gas sensor housing can have one or more of a number of configurations. FIGS. 3A and 3B show another inner portion 302, different from the inner portion 202 of FIGS. 2A and 2B, of a gas sensor housing in accordance with certain example embodiments. FIG. 3A shows a cross-sectional side view of the inner portion 302, and FIG. 3B shows a cross-sectional front view of the inner portion 302. The inner portion 302 of FIGS. 3A and 3B is substantially the same as the inner portion 202 of FIGS. 2A and 2B, except as described below.

As discussed above, a component (e.g., side wall 207, cavity 230) of the inner portion 202 of FIGS. 2A and 2B is substantially the same as a corresponding component (e.g., side wall 307, cavity 330) of the inner portion 302 of FIGS. 3A and 3B, where the last two digits of such component of the inner portion 202 and the corresponding component of the inner portion 302 are the same. Referring to FIGS. 1A-3B, the inner portion 302 of FIGS. 3A and 3B has some additional coupling features relative to the inner portion 202 of FIGS. 2A and 2B.

For example, in this case, the side walls 307 of the inner portion 302 have additional coupling features disposed therein relative to the side walls 207 of the inner portion 202. Specifically, the inner portion 302 of FIGS. 3A and 3B includes an optical device coupling feature 310 (which is disposed in the top wall 205 of the inner portion 202 of FIGS. 2A and 2B) and an additional optical device coupling feature 320 disposed in the side walls 307. In certain example embodiments, the optical device coupling feature 320 (or a portion thereof) can couple, directly or indirectly, to an optical device (e.g., optical device 725 of FIG. 7 below). The optical device coupling feature 320 can have a shape and size to host one or more of a number of optical devices.

The optical device coupling feature 320 can be disposed at any location along an inner surface of a wall (e.g., side wall 307) that forms the cavity 330. For example, as shown in FIGS. 3A and 3B, the optical device coupling feature 320 can be disposed in the side wall 307 at a particular lateral location relative to the tuning fork coupling feature 340 adjacent to the cavity 330. The optical device coupling feature 320 can include any of a number of features (e.g., a collar, a notch, a protrusion, a recess) to help in coupling an optical device with the optical device coupling feature 320. In addition, the optical device coupling feature 320 can be disposed on another wall (e.g., bottom wall 308) of the inner portion 302 adjacent to the cavity 330.

Similarly, the optical device coupling feature 310 (or a portion thereof) can couple, directly or indirectly, to a different optical device (e.g., optical device 715 of FIG. 7 below). The optical device coupling feature 310 can have a shape and size to host one or more of a number of optical devices. The optical device coupling feature 310 can be disposed at any location along an inner surface of a wall (e.g., side wall 307) that forms the cavity 330. For example, as shown in FIGS. 3A and 3B, the optical device coupling feature 310 can be disposed in the side wall 307 at a particular lateral location relative to the tuning fork coupling feature 340 and to the optical device coupling feature 320, adjacent to the cavity 330. The optical device coupling feature 310 can include any of a number of features (e.g., a collar, a notch, a protrusion, a recess) to help in coupling an optical device with the optical device coupling feature 310. In addition, the optical device coupling feature 310 can be disposed on another wall (e.g., bottom wall 308) of the inner portion 302 adjacent to the cavity 330.

The wall in which the optical device coupling feature 310 is disposed can be the same wall as, or a different wall than, the wall in which the optical device coupling feature 320 is disposed. For example, in this case, the optical device coupling feature 310 is disposed in a side wall 307 that is at an opposite end of the inner portion 302 relative to the side wall 307 in which the optical device coupling feature 320 is disposed. In addition, or in the alternative, the optical device coupling feature 320 and the receiving channel coupling feature 386 can be disposed in the same wall 307 (as shown in FIGS. 3A and 3B) or a different wall of the inner portion 302. Further, the optical device coupling feature 310 and the distribution channel coupling feature 387 can be disposed in the same wall 307 (as shown in FIG. 3A) or a different wall of the inner portion 302.

Also, the tuning fork coupling feature 340 in this case is an aperture that traverses the bottom wall 308 of the inner portion 302. Further, while not shown in FIGS. 3A and 3B, the inner portion 302 can include one or more passageways (such as passageway 209 of the inner portion 202 of FIGS. 2A and 2B) and/or one or more coupling features (such as coupling feature 206 of the inner portion 202 of FIGS. 2A and 2B).

FIG. 4 shows a cross-sectional side view of a gas sensor housing 401 in accordance with certain example embodiments. In this case, the gas sensor housing 401 includes the inner portion 202 of FIGS. 2A and 2B disposed within the outer portion 199 of FIGS. 1A and 1B. Referring to FIGS. 1A-2B, the inner portion 202 includes a bottom wall 208 that is coupled to (e.g., abuts against) the inner surface of the bottom wall 185 of the outer portion 199. In addition, the housing 401 of FIG. 4 includes a passageway 209 disposed in the bottom wall 208 of the inner portion 202, where the passageway 209 is aligned with a passageway 183 that is disposed in the bottom wall 185 of the outer portion 199. Similarly, the housing 401 of FIG. 4 includes a coupling feature 206 disposed in the bottom wall 208 of the inner portion 202, where the coupling feature 206 is aligned with a coupling feature 184 that is disposed in the bottom wall 185 of the outer portion 199.

FIG. 5 shows a cross-sectional side view of another gas sensor housing 501 in accordance with certain example embodiments. In this case, the gas sensor housing 501 includes the inner portion 302 of FIGS. 3A and 3B disposed within the outer portion 199 of FIGS. 1A and 1B. Referring to FIGS. 1A-3B, the inner portion 302 includes a bottom wall 308 that is coupled to (e.g., abuts against) the inner surface of the bottom wall 185 of the outer portion 199. In addition, the housing 501 of FIG. 5 includes a tuning fork coupling feature 340 disposed in the bottom wall 308 of the inner portion 302, where the tuning fork coupling feature 340 is aligned with a tuning fork coupling feature 141 that is disposed in the bottom wall 185 of the outer portion 199. In this case, the outer portion 199 of the housing 501 of FIG. 5 does not include the passageway 183 or the coupling feature 184 shown in FIG. 4.

FIG. 6 shows a semi-transparent cross-sectional top side perspective view of a portion 600 of a gas sensor module in accordance with certain example embodiments. In this case, the portion 600 of the gas sensor module includes the housing 401 of FIG. 4, along with some additional components of the gas sensor module. Referring to FIGS. 1A-6, the additional components shown in FIG. 6 include an inlet tube 192, an outlet tube 191, a distribution channel 178, a receiving channel 173, an optical device 115, and a tuning fork 145.

The inlet tube 192 receives gas 694, which includes test gas 695, from some component (e.g., an inlet header) of the gas sensor module or other external device. The inlet tube 192 delivers the gas 694 into the cavity 158 of the outer portion 199 of the housing 401. In certain example embodiments, the inlet tube coupling feature 150 of the outer portion 199 of the housing 401 is coupled, directly or indirectly, to the inlet tube 192. The inlet tube 192 and/or the inlet tube coupling feature 150 can include one or more coupling features (e.g., a threaded coupling) to help couple the inlet tube 192 and the inlet tube coupling feature 150 to each other.

The distribution channel 178 is coupled to the distribution channel coupling feature 287. In some cases, the distribution channel coupling feature 287 can be part of a distribution channel 178. The distribution channel 178 receives some of the gas 694 in the cavity 158 of the outer portion 199 and transports the gas 694 into the cavity 230 of the inner portion 202 of the housing 401. When the gas 694 is brought into the cavity 230 by the distribution channel 178, the gas 694 becomes test gas 695. In this case, one end of the distribution channel 178 is disposed in the cavity 158 of the outer portion 199, and the other end of the distribution channel 178 is disposed in the distribution channel coupling feature 287 of the inner portion 202. In certain example embodiments, the distribution channel 178 (or portions thereof) can include a partition, as with the partition 188 described above with respect to the cavity 158 of the outer portion 199, to help control the flow of the test gas as the test gas flows to the cavity 230 of the inner portion 202.

When the test gas 695 reaches the cavity 230 of the inner portion 202 of the housing 401, the test gas 695 is tested by one or more components of the sensor module. In this example, the test gas 695 is tested using the tuning fork 145, which is coupled to (e.g., disposed in) the tuning fork coupling feature (hidden from view in FIG. 6 by the tuning fork 145) of the inner portion 202, and the optical device 115, which is coupled to (e.g., disposed in) the optical device coupling feature 210 of the inner portion 202.

The optical device 115 coupled to the optical device coupling feature 210 can be an assembly of one or more components (e.g., lens, light source) that uses any type of optical and/or other technology. For example, the optical device 115 can include a photodiode assembly. As another example, the optical device 115 can include a laser diode assembly. If the optical device 115 includes a lens, the lens can be a plano-convex lens that has a focus at some point in the cavity 230. The optical device 115 can be coupled directly or indirectly to the optical device coupling feature 210. For example, the optical device 115 can include, or can be coupled to, a SubMiniature version A (SMA) connector, which in turn is coupled to the optical device coupling feature 210.

If the optical device 115 includes a light source, the light source can generate light that is directed toward the cavity 230, either directly or indirectly (e.g., through a lens) of the optical device 115. The light generated and emitted by the light source can be of any suitable wavelength, depending on one or more of a number of factors, including but not limited to the gas being tested, the temperature, and the characteristics of the lens of the optical device 115. The light source of the optical device 115 can be coupled to a power source (e.g., a driver), which can provide power and/or control signals to the light source and/or other components of the optical device 115.

The light source can include one or more of a number of components, including but not limited to a light element (e.g., a diode, a bulb) and a circuit board. If the optical device 115 includes a lens, the lens can be capable of receiving light (e.g., from a light source) and processing the light to create light 139 that is transmitted to a particular location within the cavity 230. The optical device 115 can have any shape (e.g., sphere, semi-sphere, pyramid) and size that conforms to one or more contours of the optical device coupling feature 210.

The optical device 115 can be made of one or more suitable materials, including but not limited to silica and glass. In any case, the optical device 115 is resistant to corrosive materials, such as H₂S gas. In order for the optical device 115 to transmit the light to a particular location within the cavity 230, a number of factors must be balanced. Such factors can include, but are not limited to, the orientation of the optical device 115, the material of the optical device 115, the position of the optical device 115 relative to the tuning fork 145 in the cavity 230, and the wavelength of the light. In certain example embodiments, a sealing member (e.g., a gasket, an o-ring, silicone) can be used to provide a barrier that prevents potentially corrosive materials in the cavity 230 from entering the optical device coupling feature 210.

In certain example embodiments, the light 139 transmitted from the optical device 115, perhaps with the aid of a lens, is directed to particular point within the cavity 230. The particular point can be with respect to a portion of the tuning fork 145, described below. An example of such a particular point is approximately two-thirds up the length of a tine 147 (or between multiple tines 147) of the tuning fork 145. When the gas molecules of the test gas 695 interact with the light waves 139 generated by the optical device 115 and directed into the cavity 230, the gas molecules of the test gas 695 become stimulated. Thus, the channel 178 is positioned and/or configured in such a way that the test gas 695 emitted into the cavity 230 can more easily interact with the light waves 139 within the cavity 130.

As discussed above, the cavity 230 of the inner portion 202 can be formed by more than one piece. In such a case, the inner surface of the walls (e.g., side wall 207, bottom wall 208) of the pieces of the inner portion 202 of the housing 401 can be highly machined so that the junctions where the multiple pieces meet within the cavity 230 provide little to no seems that could impede the flow or the testing of the gas within the cavity 230. The test gas 695 that is distributed into the cavity 230 can include one or more elements (e.g., carbon, hydrogen) that can combine to form one or more compounds (e.g., methane). In some cases, the gas can also have impurities (e.g., H₂S) that can be detected, both in existence and in amount, using the optical gas sensor.

The tuning fork 145 can include one or more components and/or features. For example, the tuning fork 145 can include one or more tines 147, a base 346, an adapter (not shown), one or more conductors 166, and circuitry 196 (e.g., driver, receiver). The tines 147 of the tuning fork 145 can be positioned such that the light 139 emitted by an optical device 115 into the cavity 230 is directed between the tines 147. When the gas molecules of the test gas 695, stimulated by the light waves 139 in the cavity 230, reach the tines 147, the stimulated gas molecules can change the frequency at which the tines 147 vibrate. Specifically, impurities in the test gas 695, when stimulated by the light waves 139 directed into the cavity 230, can cause the frequency at which the tines 147 vibrate to change.

The tuning fork 145, coupled to (e.g., disposed in) the tuning fork coupling feature 240 of the inner portion 202 of the housing 401, can be any type of device that vibrates at one or more frequencies. The tuning fork 145 can have one or more components. For example, in this case, the tuning fork 145 has multiple (e.g., two, three, four) tines 147 and a base 146 from which the tines 147 extend. The tines 147 can be at least partially flexible, so that the shape of the tines 147 can change. When the shape of the tines 147 changes, the tines 147 can vibrate at a different frequency. The tuning fork 145 (including any of its components, such as the tines 147) can be made of any suitable material, including but not limited to quartz. In any case, the tuning fork 145 can be resistant to corrosive materials, such as H₂S gas.

The tines 147 of the tuning fork 145 can be oriented in any of a number of suitable ways within the cavity 230. For example, the tines 147 can be substantially parallel to the inner surface of the bottom wall 208 and substantially perpendicular to the side walls 207 in which the distribution channel coupling feature 287 and the receiving channel coupling feature 286 are disposed. In certain example embodiments, a sealing member (e.g., a gasket, an o-ring, silicone) (not shown) can be used to provide a barrier that prevents potentially corrosive materials in the cavity 230 from entering the tuning fork coupling feature 240.

The tines 147 of the tuning fork 145 can vibrate based on something other than the stimulated gas molecules within the cavity 230. For example, a driver (part of the circuitry 196) can be coupled to the tuning fork 145. In such a case, the driver can provide a vibration frequency to the tuning fork 145, causing the tines 147 to vibrate at a certain frequency. Such a frequency may be substantially similar to a frequency induced by a pure form (without any impurities) of the gas being stimulated within the cavity 230.

To measure the frequency at which the tines 147 of the tuning fork 145 are vibrating, one or more measuring devices can be used. For example, a receiver (also part of the circuitry 196) can be coupled to the tuning fork 145. In such a case, the receiver can determine a vibration frequency to the tuning fork 145. Thus, when the vibration frequency of the tines 147 changes, the measured change can be directly correlated to an impurity in the test gas injected through the channel into the cavity 230.

The circuitry 196 (e.g., the driver, the receiver) can be coupled to the tuning fork 145 in one or more of a number of ways. For example, as shown in FIG. 6, one or more electric conductors 166 can be coupled between the base 146 of the tuning fork 145 and the circuitry 196. In certain alternative embodiments, wireless technology can be used to couple the circuitry 196 to the rest of the tuning fork 145. Once the test gas 695 is tested at the tuning fork 145, the gas becomes tested gas 696 and continues through the cavity 230 toward the receiving channel coupling feature 286.

In certain example embodiments, a receiving channel 173 is coupled to the receiving channel coupling feature 286 of the inner portion 202 of the housing 401. In some cases, the receiving channel coupling feature 286 can be part of the receiving channel 173. The receiving channel 173 receives the tested gas 696 in the cavity 230 and transports the tested gas 696 from the cavity 230 of the inner portion 202 to the cavity 158 of the inner portion 199 of the housing 401. In this case, one end of the receiving channel 173 is disposed in the cavity 158 of the outer portion 199, and the other end of the receiving channel 173 is disposed in the receiving channel coupling feature 286 of the inner portion 202. In certain example embodiments, the receiving channel 173 (or portions thereof) can include a partition, as with the partition 188 described above with respect to the cavity 158 of the outer portion 199, to help control the flow of the tested gas 696 as the tested gas 696 flows to the cavity 158 of the outer portion 199.

The outlet tube 191 sends gas 694, including tested gas 696, from the cavity 158 of the outer portion 199 of the housing 401 to a component (e.g., an outlet header) of the gas sensor module or other external device. The outlet tube coupling feature 155 of the outer portion 199 of the housing 401 can be coupled, directly or indirectly, to the outlet tube 191. The outlet tube 191 and/or the outlet tube coupling feature 155 can similarly include one or more coupling features to help couple the outlet tube 191 and the outlet tube coupling feature 155 to each other.

In certain example embodiments, the sensor module can have one or more channels (e.g., channel 173, channel 178) disposed in the cavity 158 of the outer portion 199. Such channels can be used, for example, to inject test gas 695 into and/or remove tested gas 696 from the cavity 230 of the inner portion 202 of the housing 401. Channel 178 can be disposed in a different location (relative to the location of channel 173) in the inner portion 202 of the housing 401. Each channel can have any of a number of features, shapes, sizes, and/or orientations. For example, in this case, channel 173 and channel 178 are each substantially linear. The channel wall of a channel can be coated with one or more of a number of materials. In addition, or in the alternative, the channel wall of a channel can have a sleeve or some similar component of the gas sensor module disposed therein. Further, a channel can have any of a number of characteristics (e.g., size, cross-sectional shape, length, width) suitable for the gas sensor module.

When the test gas 694 enters the cavity 158 of the outer box 199 through the inlet tube 192, it a relatively high concentration and pressure. This is, in part, due to the presence of the inner portion 202 of the housing within the cavity 158 of the outer portion 199. In this case, the cavity 230 of the inner portion 202 forms a low concentration region of the test gas 695, and a diffusion mechanism is triggered in the cavity 230. According to diffusion properties of gases, the gas molecules tend to diffuse or spread out from a region of high concentration (in this case, cavity 158) to region of low concentration (in this case, cavity 230). The tuning fork 145 is disposed in the cavity 230 of the inner portion 202, and so is not affected by the flow of the test gas 695 because the concentration of the test gas 695 in the cavity 230 of the inner portion 202 is due purely to diffusion.

After a while, equilibrium is reached, making the concentration in both the cavity 230 and the cavity 158 substantially the same. The light source (e.g., laser) of the optical device 115 is tuned on to shine light 139 through the lens of the optical device 115 at any point in between the tines 147 (e.g., ⅓ of the length of the tines 147 measured from the end of the tines 147) of the tuning fork 145. When the optical energy of a particular wavelength (chosen according to the test gas 695) is absorbed by the test gas 695, the molecules of the test gas 695 present in the cavity 230 generate acoustic signals, which generates a change in resonance frequency of the tines 147 of the tuning fork 145 that is proportional to the concentration of the test gas 695 in the cavity 230, with very low impact of flow of the test gas 695 on the tuning fork 145 or other components of the sensor module.

FIG. 7 shows a semi-transparent cross-sectional top side perspective view of another portion 700 of a gas sensor module in accordance with certain example embodiments. In this case, the portion 700 of the gas sensor module includes the housing 501 of FIG. 5, along with some additional components of the gas sensor module. Referring to FIGS. 1A-7, the additional components shown in FIG. 7 include an inlet tube 792, an outlet tube 791, a distribution channel 778, a receiving channel 773, an optical device 715, an optical device 725, and a tuning fork 745. The components of the portion 700 of the gas sensor module of FIG. 7 are substantially the same as the corresponding components of the portion 600 of the gas sensor module of FIG. 6, except as described below.

As discussed above, a component (e.g., tuning fork 745, inlet tube 792, the test gas 795) of the portion 700 of the gas sensor module of FIG. 7 is substantially the same as a corresponding component (e.g., tuning fork 145, inlet tube 192, the test gas 695) of the portion 600 of the gas sensor module of FIG. 6, where the last two digits of such component of the portion 700 and the corresponding component of the portion 600 are the same. Referring to FIGS. 1A-7, the optical device 715, coupled to the optical device coupling feature 310 of the inner portion 302, is now disposed in the side wall 307 of the inner portion 302 in which the inlet tube coupling feature 387 is also disposed.

In addition, there is an additional optical device 725 coupled to the optical device coupling feature 320 of the inner portion 302 of the housing 501. The optical device 725 coupled to the optical device coupling feature 320 can be an assembly of one or more components (e.g., lens, light source) that uses any type of optical and/or other technology. The optical device 725 can be substantially the same as, or different than, the optical device 715. For example, optical device 725 can include a laser diode assembly when the optical device 715 includes a photodiode assembly. If the optical device 725 includes a lens, the lens can be a plano-convex lens that has a focus at some point in the cavity 330. The optical device 725 can be coupled directly or indirectly to the optical device coupling feature 320. For example, the optical device 725 can include, or can be coupled to, a SMA connector, which in turn is coupled to the optical device coupling feature 320. The optical device 725 can include one or more of a number of components, such as the components (e.g., lens, light source) described above for the optical device 715.

In certain example embodiments, optical device 715 and optical device 725 each include a lens and are placed at opposite ends of the cavity 330 with the tines 747 of the tuning fork 745 in the direct linear path of light 739 between the two lenses. In this case, the tuning fork 745 is oriented upright within the cavity 330, as opposed to laying down within the cavity 230 of FIG. 6. Further, the focus of the converging lenses of optical device 715 and optical device 725 lies substantially exactly in between the tines 747 of the tuning fork 745 and also at a height (e.g., two-thirds of the height of the tines 747) relative to the base 746 of the tuning fork 745. In such a case, optimal optical alignment can be achieved as all three elements (optical device 715, optical device 725, and tuning fork 745) are aligned along a central axis.

In some cases, if the two lenses of the optical devices have substantially the same focus, improved measurements of the test gas 795 can be taken. For example, the optical alignment with a laser 739 of one optical device (e.g., optical device 715) directed through its lens can be detected by a photo-diode of the other optical device (e.g., optical device 725) through its lens. Further, if the lenses of the optical devices are converging, maximum energy can be focused between the tines 747 of the tuning fork 745, creating a maximum interaction of a laser 739 (light) with test gas molecules 795 at that point, resulting in an increased sensitivity and improved measurements.

In certain example embodiments, as shown in FIG. 6 above, the inner portion 202 of the housing 401 has only a single optical device coupling feature that couples to a single optical device. Alternatively, the inner portion of the housing can have more than two optical device coupling features that couple to more than two optical devices. When the inner portion 302 of the housing 501 has two optical device coupling features that couple to two optical devices, they can be aligned with each other at opposite ends of the cavity 330, as shown in FIG. 7. Alternatively, the two optical device coupling features (and thus the two optical devices) can be disposed at any point with respect to each other in the cavity 330.

Again, all of the measurement components (e.g., tuning fork 745, optical devices 715 and 725 (which can include micro-resonators 738, a laser diode, a photodiode, and lenses)) are coupled to coupling features of the inner portion 302 of the housing 501. This arrangement of components of the gas sensor module helps in achieving tight alignment and also reduces the impact of flow of the test gas 795 due to the diffusion process. At equilibrium, the concentration of gas 794 in the cavity 158 and test gas 795 in the cavity 330 is substantially the same. The light source (e.g., laser) of an optical device (e.g., optical device 725) is turned on to shine light 739 through lens at a point in between the tines 747 of the tuning fork 745 where highest sensitivity is achieved.

A photodiode of an optical sensor (e.g., optical sensor 715) placed at the opposite end of the cavity 330 of the lower portion 302 captures the light 739 passing through the tines 747 of the tuning fork 745, allowing for proper optical alignment. The optical energy of a particular wavelength (chosen according to the test gas 795) is absorbed by the molecules of the test gas 795 present in the cavity 330. As a result, acoustic signals are generated, producing a change in resonance frequency that is proportional to the concentration of the test gas 795. In addition, because of the precise alignment of the optical sensor 715, the tuning fork 745, and the optical sensor 725, sensor sensitivity is increased, leading to improved measurement performance. The sensor sensitivity is further increased by using micro-resonators 738, which helps in amplifying the signal detected by the sensor module.

In certain example embodiments, a micro-resonator 738 (also called a microresonator 738) is one or more devices that each form an elongated tube. The micro-resonator 738 can be disposed in the cavity 330 so that the light 739 emitted by an optical device (e.g., optical device 725) can travel therethrough before reaching the tuning fork 745. In addition, the micro-resonator 738 (the same micro-resonator or a separate micro-resonator) can be positioned within the cavity 330 between the tuning fork 745 and another optical device (e.g., optical device 715). In such a case, the light 739 that passes through the tines 747 of the tuning fork 745 can continue to pass through the micro-resonator 738 to the other optical device, where the light 739 is measured.

The micro-resonator 738 is a small-scale structure or group of structures that are designed to confine and/or otherwise manipulate the light 739. The light 739 is reflected internally along the inner surface of the micro-resonator 738. This creates a series of standing-wave optical modes, or resonances, similar to those that can exist on a vibrating guitar string. The micro-resonators 738 can thus also be used in this case to align the tuning fork 745 and allow for more precise measurements. The micro-resonator 738 (or portions thereof) can be part of, or separate from, an optical device (e.g., optical device 715, optical device 725).

Example embodiments provide a number of benefits. Examples of such benefits include, but are not limited to, compliance with one or more applicable standards (e.g., IP65, IEC 60079-28, Zone 1 or Zone 2 compliance), ease in maintaining and replacing components, and more accurate and quicker detection and measurement of impurities in gases. The example housing described herein can reduce/control the effects of flow and/or turbulence of the test gas and/or the tested gas. Example embodiments can also allow for better alignment accuracy within the sensor head cavity so that the test gas can be more accurately tested. The shape, size, and other characteristics of the various components of a gas sensor module, including the example housing described herein, can be engineered to achieve optimal flow rate, minimal turbulence, optimal efficiency, and/or any of a number of other performance metric.

Specifically, example embodiments provide controlled (e.g., low) flow rates, which improves the measurement performance of the measurement components (e.g., tuning fork, optical device(s)) of the gas sensor module. The example “box-in-box” configuration of example embodiments reduces the impact of flow of the test gas due to diffusion, and yet maintains the concentration of the test gas in the inner portion of the housing. The use of micro-resonators can be used in example embodiments to improve alignment of the laser and the tuning fork tines, while also reducing the impact of flow of the test gas and increasing the measurement effectiveness (the sensitivity) of the sensor module.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A housing for a gas sensor module, the housing comprising:
an outer portion comprising:
at least one first wall forming a first cavity;
an inlet tube coupling feature disposed at a first location in the at least one first wall, wherein the first location is adjacent to the first cavity;
an outlet tube coupling feature disposed in a second location in the at least one first wall, wherein the second location is adjacent to the first cavity; and
an inner portion disposed within the first cavity, wherein the inner portion comprises:
at least one second wall forming a second cavity;
a distribution channel coupling feature disposed at a third location in the at least one second wall, wherein the third location is adjacent to the second cavity;
a receiving channel coupling feature disposed in a fourth location in the at least one second wall, wherein the fourth location is adjacent to the second cavity; and
a tuning fork coupling feature disposed at a fifth location in the at least one second wall, wherein the fifth location is adjacent to the second cavity.

2. The housing of claim 1, wherein the inner portion is substantially shaped as a rectangular parallelepiped.

3. The housing of claim 2, wherein the inner portion is disposed on the at least one first wall of the outer portion.

4. The housing of claim 3, wherein the outer portion further comprises an additional tuning fork coupling feature disposed at a sixth location in the at least one first wall, wherein the additional tuning fork coupling feature is aligned with the tuning fork coupling feature when the inner portion is disposed on the at least one first wall of the outer portion.

5. The housing of claim 1, wherein the inner portion further comprises:
a first optical device coupling feature disposed at a sixth location in the at least one second wall, wherein the sixth location is adjacent to the second cavity.

6. The housing of claim 5, wherein the inner portion further comprises:
a second optical device coupling feature disposed at a seventh location in the at least one second wall, wherein the seventh location is adjacent to the second cavity.

7. The housing of claim 1, wherein the at least one first wall comprises at least one housing coupling feature, and wherein the at least one second wall comprises at least one complementary housing coupling feature that couples to the at least one housing coupling feature of the outer portion.

8. The housing of claim 1, further comprising:
a receiving channel coupled to the receiving channel coupling feature of the inner portion, wherein at least a portion of the receiving channel is disposed in the first cavity of the outer portion.

9. The housing of claim 1, further comprising:
a distribution channel coupled to the distribution channel coupling feature of the inner portion, wherein at least a portion of the distribution channel is disposed in the first cavity of the outer portion.

10. The housing of claim 1, wherein the inlet tube coupling feature is configured to receive an inlet tube of a gas sensor module, and wherein the outlet tube coupling feature is configured to receive an outlet tube of the gas sensor module.

11. The housing of claim 1, wherein the tuning fork coupling feature is configured to receive a tuning fork of a gas sensor module.

12. The housing of claim 1, wherein the outer portion is removably coupled to the inner portion.

13. A gas sensor, comprising:
a housing comprising;
an outer portion comprising:
at least one first wall forming a first cavity;
an inlet tube coupling feature disposed at a first location in the at least one first wall, wherein the first location is adjacent to the first cavity;
an outlet tube coupling feature disposed in a second location in the at least one first wall, wherein the second location is adjacent to the first cavity;
an inner portion disposed within the first cavity of the outer portion, wherein the inner portion comprises:
at least one second wall forming a second cavity;
a tuning fork coupling feature disposed at a third location in the at least one second wall, wherein the third location is adjacent to the second cavity;
a distribution channel disposed at a fourth location in the at least one second wall, wherein the fourth location is adjacent to the second cavity; and
a receiving channel disposed at a fifth location in the at least one second wall, wherein the fifth location is adjacent to the second cavity;
an inlet tube coupled to the inlet tube coupling feature;
an outlet tube coupled to the outlet tube coupling feature; and
a tuning fork coupled to the tuning fork coupling feature.

14. The gas sensor of claim 13, further comprising:
a first optical device coupled to a first optical device coupling feature, wherein the first optical device coupling feature is disposed in a sixth location in the at least one second wall of the inner portion, wherein the sixth location is adjacent to the second cavity.

15. The gas sensor of claim 14, wherein the first optical device is disposed, at least in part, in the first cavity.

16. The gas sensor of claim 14, further comprising:
a second optical device coupled to a second optical device coupling feature, wherein the second optical device coupling feature is disposed in a seventh location in the at least one second wall of the inner portion, wherein the seventh location is adjacent to the second cavity.

17. The gas sensor of claim 16, wherein the second optical device is disposed, at least in part, in the first cavity.

18. The gas sensor of claim 16, wherein the first optical device and the second optical device are directed at each other through the second cavity.

19. The gas sensor of claim 18, wherein the tuning fork is disposed in a direct path between the first optical device and the second optical device within the second cavity.

20. The gas sensor of claim 19, further comprising:
at least one micro-resonator disposed within the second cavity adjacent to the tuning fork, wherein light emitted by the first optical device is projected through the at least one micro-resonator.
